(19) United States
(12) Patent Application Publication
(10) Pub. No.: US 2004/0123147 A1
(43) Pub. Date: Jun. 24, 2004

(54) Control of security or ease-of-use sensitivity for a wireless communication device

(76) Inventor: Christopher White, Redmond, WA (US)

Correspondence Address: PERKINS COIE LLP/AWS, P.O. BOX 1247, SEATTLE, WA, 98111-1247, US

(21) Appl. No.: 10/324,870

(22) Filed: Dec. 19, 2002

(51) Int. Cl. G06F 11/30

(52) U.S. Cl. 713/201

(57) ABSTRACT

A system and method for controlling the security or accessibility of a wireless communication device is disclosed herein. Security preference settings are configured for the wireless communication device. Depending on the security preference settings, the user interface(s) of the wireless communication device may be appropriately changed to provide the set level of device security or accessibility.

### CROSS-REFERENCE TO RELATED APPLICATION(S)

The present application is related to U.S. application Ser. No. ______ (Attorney Docket No. 101948086US) entitled “Conditional Application Invocation in a Wireless Device” by Christopher White; U.S. application Ser. No. ______ (Attorney Docket No. 101948087US) entitled “Automated Device Behavior Management Based on Network Charging and Rating Conditions” by Christopher White; and U.S. application Ser. No. ______ (Attorney Docket No. 101948088US) entitled “Automated Device Behavior Management based on Preset Preferences” by Christopher White, all filed on the same day herewith and commonly assigned to AT&T Wireless Services, Inc.

### BACKGROUND

Users of wireless communication devices agree on rating and charging terms in a service provider agreement. The network service provider, or carrier, typically offers a variety of plans with different variables. The variables include the amount of air time per billing cycle that is charged at a minimum rate, more favorable rates during “off-peak” times such as nights and weekends (as opposed to “on-peak” or “peak”) times, different rates for on-network use and roaming use, fees for special services such as call conferencing and email usage, etc. The amount of time available per billing cycle at a certain rate is sometimes referred to as the amount of time in a bucket. For example, the user typically chooses a number of minutes per month, e.g., 300 minutes per month, that are free or charged at a minimal rate. After the 300-bucket minutes are used, airtime is charged or charged at a higher rate.

Users benefit from having an awareness of how much money they will spend if they use their device at a certain time or in a certain way. For example, the user might like to know that only five minutes are left in the bucket. This rating and charging awareness is even more important with data connections than with voice connections. For example, sending or receiving email during peak hours may be more expensive than during off-peak hours. For the user to adjust device usage based on rating and charging conditions, however, the user currently must affirmatively find out what the conditions are and act or refrain from acting accordingly.

Moreover, as the usage of wireless communication devices proliferate to the extent that employers are providing such devices to employees and parents are providing such devices to their children, whether the devices are being solely used for their intended purpose (e.g., to conduct business or for emergencies) becomes an issue. Although it is possible to review a bill itemizing device usage, improper usage, if any, would have already occurred and would have to be paid for. Reviewing potentially thousands of bills would also be cumbersome.

Currently, the ability to automatically manage device use is very limited, costly, and awkward. For example, if a user wishes for an action to be taken based on a condition, such as having particular phone numbers disabled under certain conditions, it would be handled on an occurance-by-occurance basis at the provider site. The provider must program a local provider application to recognize that the device belonging to the particular account is making a particular call when a specified condition is current. The provider must then invoke a native application on the device, such as the call controller, to disable the specified phone numbers. This has several limitations and disadvantages. The user must make a written or verbal request to the provider. The provider must assign someone to program the provider application, and activities of the affected device must be monitored, which slows call handling. The provider can only invoke native applications, not downloaded applications, which limits the actions that can be taken in response to a condition.

Even when the behavior of the wireless device is managed, improper use is possible if the wireless device is lost, stolen, or used by an unauthorized person. In other words, controlling what actions the wireless device can take does not address who can take (even approved) actions on the wireless device. The degree of accessibility of the wireless device or various features or services available on the wireless device is also a factor as the various usage management configuration can affect how cumbersome it will be for any potential user to actually use the wireless device.

### BRIEF DESCRIPTION OF THE DRAWINGS

FIG. 1 is a block diagram illustrating one embodiment of a wireless communication system.

FIG. 2 is a block diagram of a wireless communication device included in the system of FIG. 1.

FIG. 3 is a detailed block diagram of the wireless communication device of FIG. 2.

FIG. 5 is a flow diagram illustrating one embodiment for setting performances in the system of FIG. 1.

FIG. 6 is an illustration of a graphical user interface used for settling preferences in FIG. 5.

FIG. 7 is a flow diagram illustrating one embodiment for controlling the security of the device of FIG. 2.

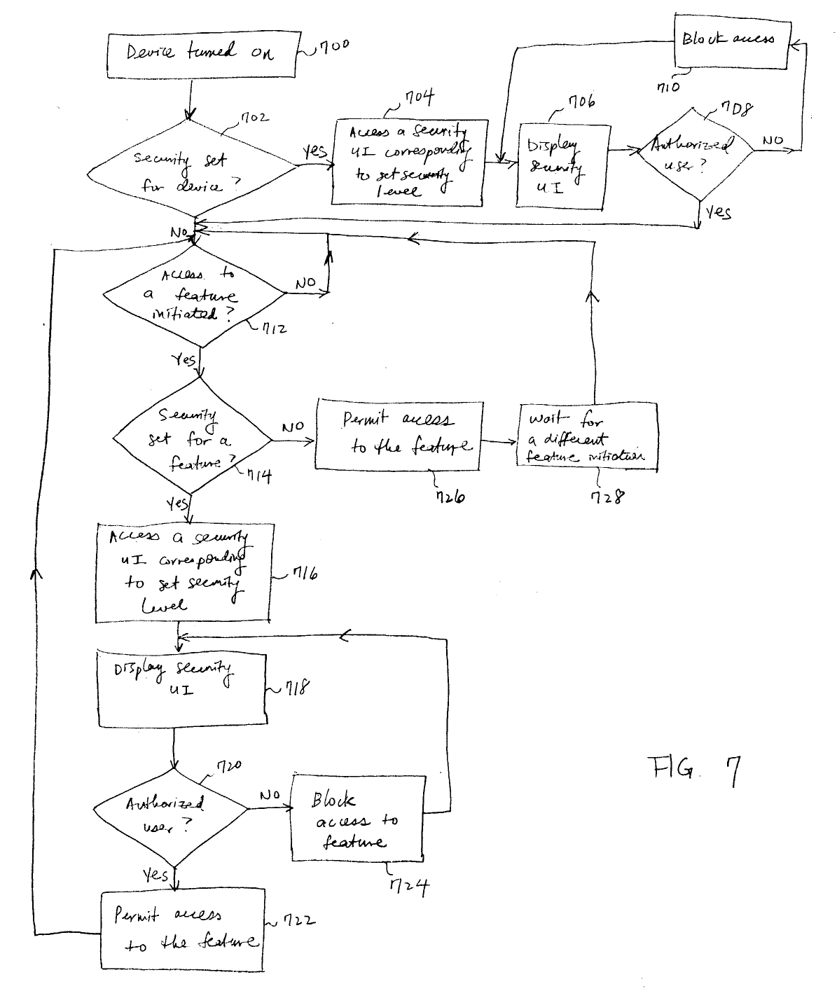

In the drawings, identical reference numbers identify identical or substantially similar elements or acts. To easily identify the discussion of any particular element or act, the most significant digit or digits in a reference number refer to the figure number in which that element is first introduced (e.g., element 704 is first introduced and discussed with respect to FIG. 7).

The headings provided herein are for convenience only and do not necessarily affect the scope or meaning of the claimed invention.

### DETAILED DESCRIPTION

Described in detail below is a system and method for providing automated management of the behavior of a wireless communication device based on preset preferences or controls. In one embodiment, authorized persons (e.g., users, parents or employers) can set preferences or controls specifying who can access the wireless communication device and the degree of accessibility of the wireless communication device to potential users. The specified preferences can reside at the service provider's network to the extent required to download such preferences to the wireless communication device(s) and to communicate new or updated preferences to the device(s). The wireless communication device can enforce the specified preferences with minimal additional resources on the part of the wireless service network or service provider. The preferences can be modified in real-time and remotely from the wireless communications device.

Accordingly, the security or accessibility level for using the wireless communication device is configurable. The security or accessibility level for certain features or services available at the wireless communication device can also be configurable. The accessibility preferences can be easily set using a slider bar, radio buttons, or other use interface tools. Depending on the level(s) of accessibility preferences selected, one or more different user interfaces (UIs) and ease-of-use sensitivity of the wireless communication device are provided so that only intended or authorized user(s) can use the wireless communication device. With the accessibility preference setting capability, a given wireless communication device need not be “matched” to or owned by one user, but instead is usable by more than one user or with different accessibility levels for different users.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of embodiments of the invention.

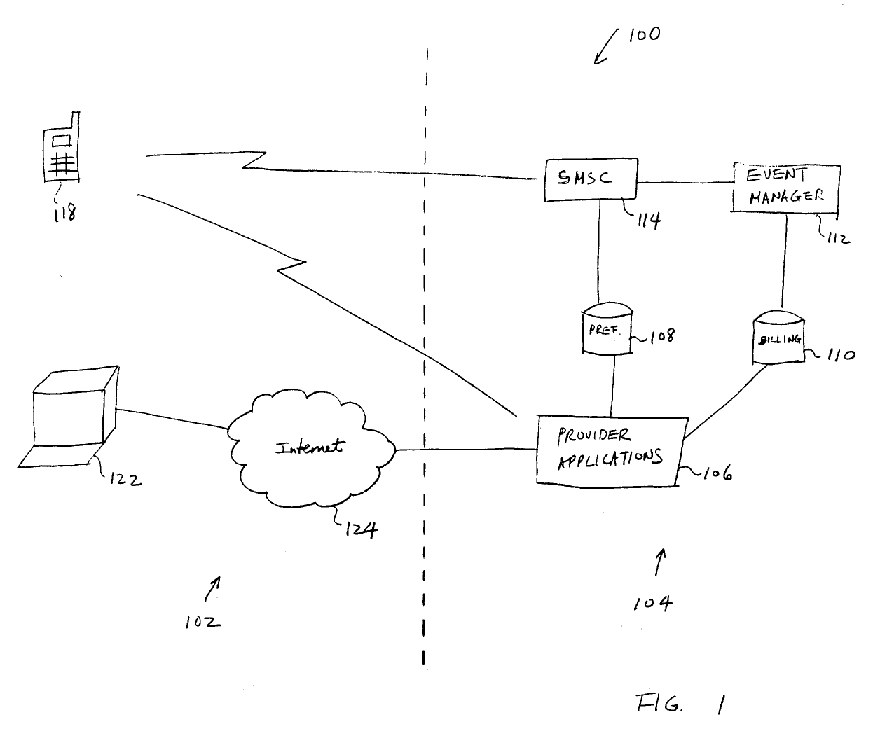

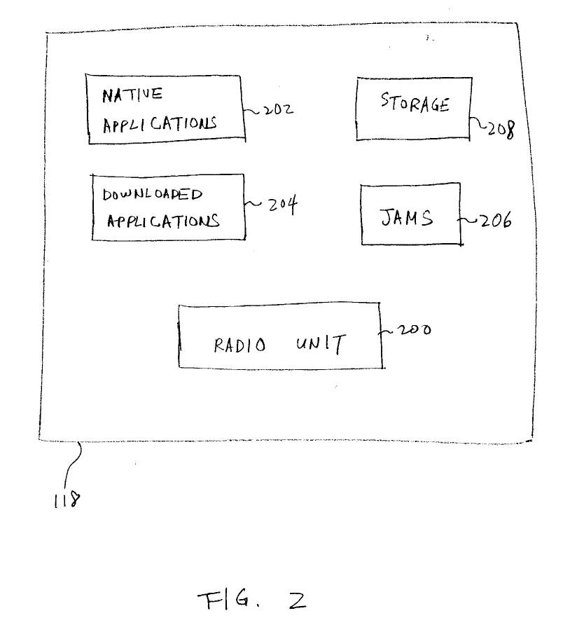

Referring to FIG. 1, one embodiment of a wireless communication system 100 is shown. The system 100 is arbitrarily divided into an area 102 and an area 104. The area 102 includes equipment and applications that are typically not provided or maintained by a wireless communication service provider, such as a cellular voice and data service provider, but which are designed to communicate on the wireless network with the provider equipment. The area 104 includes equipment and applications typically provided and maintained by the service provider. The system 100 is one example of an arrangement of elements, but others are possible. A cellular phone service provider is one example of a provider, but other examples include any wireless service provider that provides wireless communication capabilities through a user device over a wireless network. For example, service providers that support handhelds and wireless modems are also providers for purposes of the embodiments described.

In the area 102, each of a wireless communication device 118 and a computer or workstation 122 (via the Internet 124) is configured for communicating on the wireless network. An authorized person (e.g., one or more persons having a password or authority to set or modify the preferences or controls) may configure the preferences by accessing a dedicated provider configuration application included in provider applications 106. The applications 106 may be accessed using the device 118 or the computer 122. Alternatively, the preferences can be set on the device 118 without involving the provider equipment such as the applications 106.

In the area 104, various computers, data processors, and telecommunication equipment (e.g., base stations and switching centers) known to be part of the provider equipment are not shown. Provider applications 106 include software, firmware, and/or hardware for maintaining and administering the wireless network. For example, the applications 106 include billing applications, performance monitoring applications, and the like. The applications 106 further include tools that track user accounts, which are typically designated by a responsible billing party. The account may include one user with one device, or a group of many users each with a respective device. For example, some enterprises provide groups of employees with devices for limited or unlimited use in the course of employment.

The area 104 further includes databases 108 and 110 coupled to the applications 106. The databases 108, 110 are shown separately to distinguish the types of data stored, but could be one or more physical entities. The database 108 is configured to be a preference database that stores the specified preferences dictating the behavior of each given device. The database 108 is further configured to store the conditions or events associated with the specified preferences that the device is to be automatically notified of. The specified preferences for a given device stored in the database 108 may be deleted or reformatted once the specified preferences have been downloaded to the device. Alternatively, when the preferences are specified on the device 118, the database 108 need not store such preferences and thus the database may be omitted. The database 110 is a billing database that stores data used by the service provider to generate bills for an account. Billing data includes all of the information in a user's rate plan, such as the number of minutes in a bucket, bucket rates, out of bucket rates, etc.

A short message service controller (SMSC) 114, coupled to the database 108, is configured to manage short messaging, including receiving/sending, generating, and encoding/decoding short message service (SMS) messages. An event manager 112, coupled to the SMSC 114 and the database 110, is configured to recognize events that indicate a change in the current condition (e.g., change from off-peak to peak time) and in response communicates such recognition to the SMSC. Each of the SMSC 114 and the event manager 112 can be dedicated firmware, hardware, and/or software embodied in a processor or computing apparatus. Although the SMSC 114 and the event manager 112 are shown as separate devices, they may be embodied in as a single device.

The device 118 includes one or more native applications and downloaded applications. The native applications are configured to permit the device 118 to perform typical voice and/or data wireless communications such as place calls, receive calls, scan for control channels, etc. The downloaded applications may come from the service provider or a third party vendor. Downloaded applications are configured to permit the device 118 to perform additional functions such as management of emails or automatic management of device behavior. As such, downloaded applications provide further functionality and selective manipulation of the basic voice or data communications on the wireless network. The service provider need not have knowledge of the downloaded applications or configuration of the downloaded applications at the device 118.

The specified preferences, as described in detail below, are applicable at an account level (e.g., multiple devices associated with an account) device level (e.g., one device among several devices associated with an account), or feature or service level (e.g., one or more features or services available at a given device such as a text messaging service or email capability. Based on an agreed-upon service or rate plan and specified preferences, the device 118 and the components in the area 104 communicate transparently with each other to dictate which UIs and applications are to be invoked for particular users and the ease-of-use of such applications, on the device 118. The service provider does not need to intercept, monitor, or specifically process device activity in order to affect the device security/accessibility.

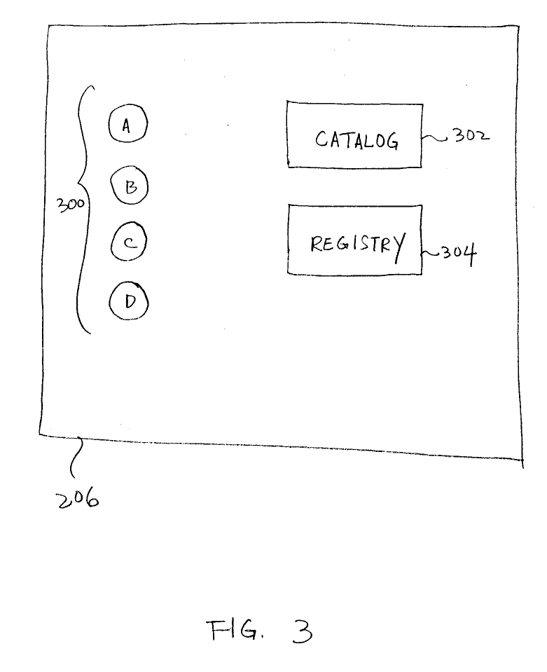

One embodiment of a block diagram of the device 1998 shown in FIG. 2. The device 118 includes a radio unit 200 configured to provide communication over the wireless network. The radio unit 200 includes hardware, firmware, and/or software such as transceiver, antenna, and signal-processor. The device 118 further includes inactive applications 202 and downloaded applications 204 as discussed herein. A Java application management service (JAMS) 206 includes Java programs and Java program management capability. A storage or memory 208 (e.g., a non-volatile memory or SEM) is configured to store at least a portion of the portion of the preference configurations. Many other known elements of the device 118, such as on-board processors, are not shown.

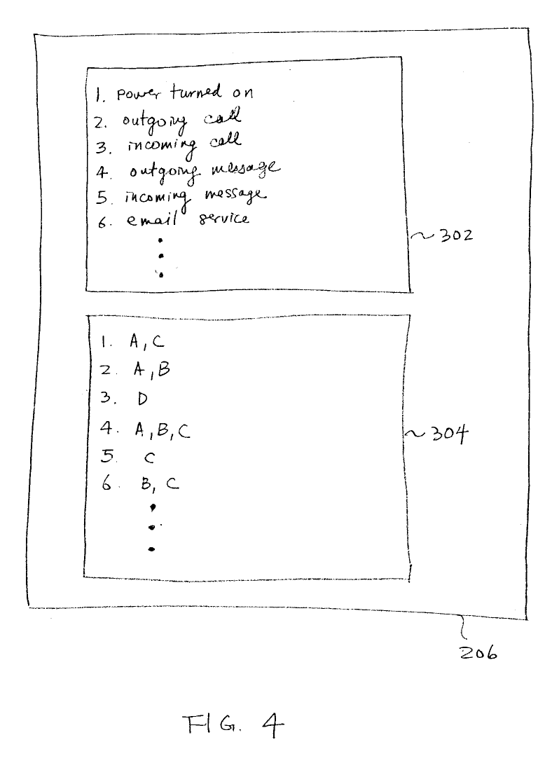

In FIGS. 3-4, more detailed block diagrams of the device 118 are shown. In one embodiment, the JAMS 206 is configured to invoke the security or accessibility preference settings. This JAMS 206 includes downloaded Java applications 300 designated A, B, C, and D. More or less than four downloaded Java applications can be provided, depending on storage capacity or types of applications required. The JAMS 206 also includes catalog 302 and a registry 304.

The catalog 302 includes a list of device conditions or states for which one or more actions will be taken per the configured preference settings. The catalog 302 is configured when new or updated preference settings are provided to the device 118. The conditions shown in FIG. 4 are a subset of possible conditions that can be recognized by the device 118. Some examples of conditions are power being turned on, outgoing call placed, incoming call received, outgoing messaging (e.g., SMS message sent), incoming messaging, and email service (shown as conditions 1 through 6, respectively).

The registry 304 is configured to identify which downloadable Java applications (A, B, C, and/or D) should be executed when a condition listed in the catalog 302 occurs at the device 118. For example, when condition 1 occurs (the device 118 is turned on), applications A and B are executed. Application A may be an application that displays a user interface screen requesting a personal identification member (PIN) to use the device. Application B may be an application that compares the inputted PIN to a stored PIN value and blocks all use of the device 118 if the inputted PIN is not an approved value.

In other embodiments, the applications listed in the registry include inactive applications as well as downloaded applications. In still other embodiments, the catalog and registry are included elsewhere in the device 188 (such as in the storage 208) instead of the JAMS 206.

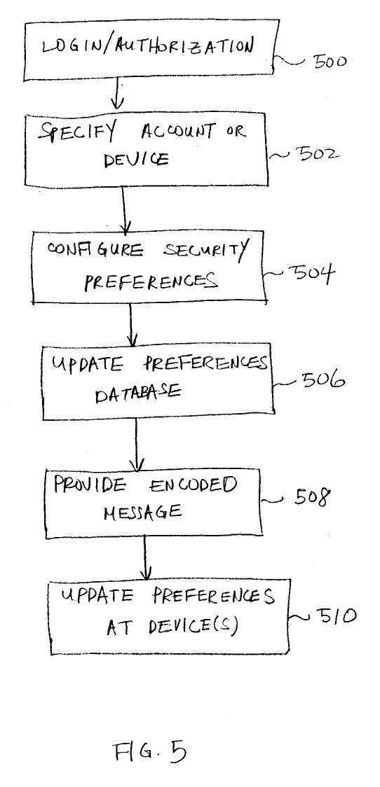

In FIG. 5, a flow diagram for setting the preferences is shown. At a block 500, an authorized person (e.g., an employer, person responsible for the account, or the user of the device) logs into or otherwise accesses an interface for setting the preferences. The preferences can be set using the computer 122, the device 188, or a variety of other devices (not shown) capable of communicating with the device 118 or the provider equipment. A password or other security feature may also be required to insure that nonauthorized persons cannot set or modify the preference settings. For example, the computer 122 accesses a website provided by the service provider, via the Internet 12A, to remotely configure the preference settings.

At a block 502, the authorized person indicates the account or device(s) for which the preferences will be specified. When two or more users are contemplated accessing the device 118, the authorized person may set a different security level preference for each user. Then each user would be required to enter a unique identifier or PIN. Alternatively, this block is optional if the account or device(s) is automatically known based on the login information or the preferences are being set using the device 118.

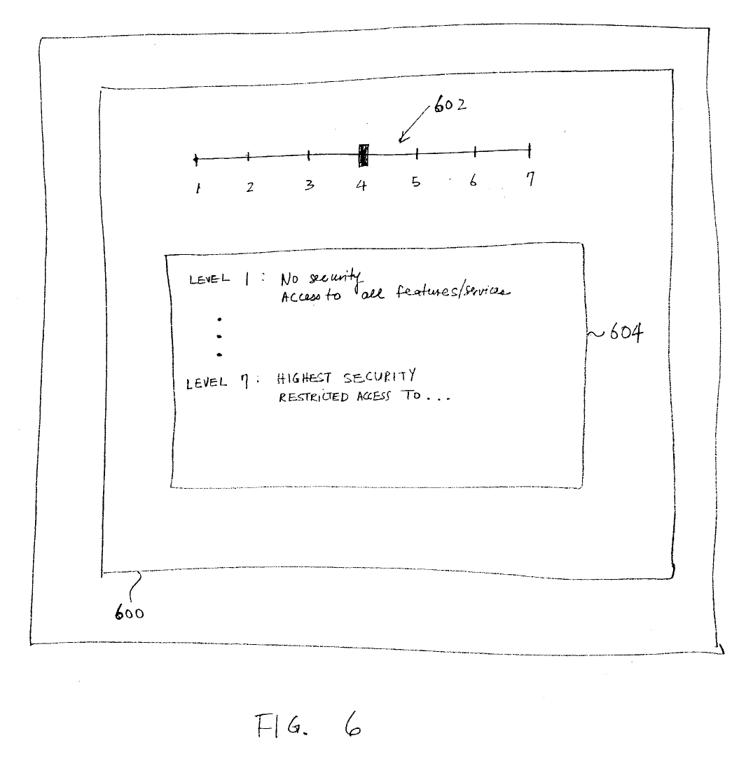

At a block 504, the security or accessibility preferences for the device 188 are configured. In one embodiment, a graphical user interface (GUI) is provided for preference configuration. As shown in FIG. 6, a display 600 (included in the computer 122 or the device 118) shows a slider bar 602 and a message 604. The slider bar 602 allows the preference level to be easily set. The slider bar 602 is moved by an input device such as up/down or left/right arrow buttons. The slider bar 602 is representative of a scale that ranges from easy-to-use (less security) on one end to hard-to-use (high security) on the other end. The message 604 explains the different levels of security preferences, and is optional if amount of space on the display 600 is limited or the authorized person is already knowledgeable about the scale range. If preferences are being set for more than one user of a given device, or for various features or services available on a given device, a different slider bar can be set for each such preference.

Once all the performers are set, the preferences are stored in the database 108 (block 506). Alternatively, the preferences are stored in real-time at the database 108 as the configuration is in progress. When the new or updated preferences are provided at the provider equipment (e.g., the database 108), the SMSC 114 generates an encoded SMS message to the device 118. At a block 508, the encoded SMS message transmitted to the device 118 indicates that new or updated preferences are available for download. The encoded message can be a general packet radio service (GPRS) signal or include a “Home GPRS available” condition in the signal.

In response, at a block 510, the device 118 opens a communication channel to the provider equipment to retrieve the new preferences. The device 118 invokes a Java application management service (JAMS) that looks for applications with a “Refresh when new data connection becomes available” flag set. Such applications accordingly start and perform preference data refresh. The catalog and/or registry 302, 304 are updated as needed per the preference settings.

For purposes of the device 118 configuration, out-of-band signals are exchanged between the device and the provider equipment. These signals may be exchanged via a hypertext transfer protocol (HTTP) connection, a wireless application protocol (WAP) connection, or any other wireless communication method (including in-bound signals).

The process illustrated in FIG. 5 is repeated each time new preferences are set for an account or device, or when preferences are updated. It is contemplated that the blocks 506-508 may be omitted if the preference settings are already stored in the device 118 or are not needed by the provider equipment.

Once the device 118 has been configured according to the preference settings, when the current condition or state of the device corresponds to a condition listed in the catalog 302, this will cause an action or inaction to occur in accordance with the registry 304. A change in the condition or state of the device 118 typically occurs due to a user's interaction with the device. An apparatus, such as one similar to the event manager 112 at the provider equipment, can be included in the device 118 to monitor the current condition and compare with the catalog 302. If a security preference has been set for the use of the device overall or for one or more specific features/services available on the device, then the registry 304 invokes the appropriate security UIs for the user to satisfy the set security measure. Hence, based on the selected preferences, differing user security interfaces are provided at the device 118. At the higher security levels, for instance, a user would need to input a security code (e.g., personal identification number (PIN), password, biometric identification, etc.) to use the device 118, except for calls to 911, 611 or 311. Periodic required changes to the security code and/or the security code comprising a certain length and combination of letters, numbers, characters, and capital/lower case may also be required.

In an alternate embodiment, the preference settings may be stored in the storage 208 and the preferences are enforced via an application included in the applications 202, 204. Referring to FIG. 7, the device 118 is turned on at block 700. If a security preference for use of the device 118 overall has been set (block 702), then an appropriate security interface is accessed and displayed on the device (blocks 704 and 706). When the potential user inputs information at a block 708 and it's the correct security information, then the device 118 assumes that the potential user is an approved user. Otherwise, if incorrect security information is inputted at the block 708, access or use of the device 118 is not permitted at a block 710.

If no device level security preference exists or the user has inputted the correct security information, then a check is performed to see whether the user has initiated access to a certain feature or service available at the device 118 in a block 712. If no feature has been accessed, then the device 118 waits for a feature initiation to occur.

If a security preference exists for the feature initiated (block 714), then an appropriate security interface is accessed (block 716), displayed (block 718), and correct security information has to be inputted (block 702) for feature accessibility (block 722). Otherwise, access to the feature is prevented at a block 724. When no security preference exists for the feature initiated (block 714), then access to the feature occurs (block 726) and then waits for the user's next action (block 728).

Thus, a range of security and accessibility levels for a wireless device can be implemented. Following are illustrations of security settings that are possible with the establishment of the preference configurations discussed herein. In a first illustration, the user of a wireless device sets the device to the lowest possible security setting. At this setting, no security UI is displayed. The user, or any person, has full access to the device and can make phone calls, and access data services available on the device.

In a second illustration, the company that a user works for has sensitive data that goes over a WAP connection. At the corporate level, the company has set all its employees' phones remotely to a security level that never falls below a level 3. At this level, for instance, all users must enter a PIN every two hours to use the phones.

In a third illustration, in addition to the company selected security level above, the user himself has selected the highest level of security. Now, for example, each time the user checks his email, he must enter a PIN in addition to entering a PIN every two hours for any use of the phone.

Various alternate embodiments are possible. For example, it is contemplated that one slider bar is used to set the security level for the device and the device's features/services. As an example, a security level 3 requires a PIN to use the device, while a security level 5 requires a first PIN to use the device, a second PIN to access email, and a third PIN to make outgoing calls.

In this manner, a system and method for providing a range of security and accessibility of a wireless communication device is disclosed herein. A range of security levels are provided and is selected remotely or locally by setting a slider bar. The device provides differing user security interface(s) based on the selected security level. The slider bar changes one element (security), but possibly results in a UI change in all aspect of device usage. Thus, unauthorized persons cannot use the device.

Although not required, aspects of the invention have been described in the general context of computer-executable instructions, such as routines executed by a general purpose computer, e.g., a server, wireless device or personal computer. Those skilled in the relevant art will appreciate that the invention can be practiced with other communications, data processing or computer system configurations, including Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers and the like. Indeed, the term “computer”, as used generally herein, refers to any of the above devices and systems, as well as any data processor. Aspects of the invention can be embodied in a special purpose computer or data processor that is specifically programmed, configured or constructed to perform one or more of the computer-executable instructions explained in detail herein. Aspects of the invention can also be practiced in distributed computing environments where tasks or modules are performed by remote processing devices, which are linked through a communications network. In a distributed computing environment, program modules may be located in both local and remote memory storage devices.

Aspects of the invention described herein may be stored or distributed on computer-readable media, including magnetic and optically readable and removable computer discs, as well as distributed electronically over the Internet or over other networks (including wireless networks). Those skilled in the relevant art will recognize that portions of the invention reside on a server computer, while corresponding portions reside on a client computer such as a mobile device. Data structures and transmission of data particular to aspects of the invention are also encompassed within the scope of the invention.

Unless the context clearly requires otherwise, throughout the description and the claims, the words “comprise,” “comprising” and the like are to be construed in an inclusive sense as opposed to an exclusive or exhaustive sense; that is tot say, in a sense of “including, but not limited to.” Words using the singular or plural number also include the plural or singular number, respectively. Additionally, the words “herein,” “above,” “below,” and words of similar import., when used in this application, shall refer to this application as a whole and not to any particular portion of this application. When the claims use the word “or” in reference to a list of two or more items, that word covers all of the following interpretations of the word: any of the items in the list, all of the items in the list, and any combination of the items in the list.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize.

All of the above U.S. patents and applications and other references are incorporated herein by reference. Aspects of the invention can be modified, if necessary, to employ the systems, functions and concepts of the various references described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all networked digital messaging systems that operate under the claims. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I claim:

1. A method for automatically managing wireless communication device access based on preference settings controlled by an authorized party, the method comprising:
remotely receiving preference settings associated with accessibility of the wireless communication device;
updating preference configuration data in the wireless communication device to reflect the preference settings;
monitoring a state of the wireless communication device and determining a change in state;
providing a user interface at the wireless communication device based on the preference settings and the monitored change in state, the user interface being configured to request information from any potential user of the wireless communication device; and
controlling access to the use of the wireless communication device or a feature available at the wireless communication device based on information provided by the potential user, wherein the information comprises user security information.

2. The method of claim 1, wherein remotely receiving the preference settings include selecting a security level from among a range of security levels at a website provided by a wireless service provider.

3. The method of claim 1, further comprising:
comparing the inputted information with stored information to determine whether the potential user is an authorized user, the stored information including data for one or more authorized users; and
providing a different user interface when the preference settings have been updated, wherein the state may be changed by an access attempt by the potential user.

4. A method for automatically managing wireless device access, the method comprising:
providing an interface at the wireless device based on one of at least three security preferences set for the wireless device, the interface being provided before a limited access feature on the wireless device becomes accessible to a potential user, and wherein the interface requests security information; and
preventing use of the limited access feature when provided security information is incorrect, wherein the limited access feature comprises at least one feature available at the wireless device.

5. The method of claim 4, further comprising setting one of the at least three security preferences from a location remote from the wireless device and the provider network.

6. The method of claim 4, further comprising setting one of the at least three security preferences via a website provided by a wireless service provider.

7. The method of claim 4, wherein one of the at least three security preferences is set by an authorized person that is other than the potential user.

8. The method of claim 4, further comprising setting one of the at least three security preferences using a slider bar icon or a button icon.

9. The method of claim 4, further comprising providing a different interface when a different one of the at least three security preferences is set.

10. The method of claim 4, wherein the at least three security preferences are security levels from among a range of security levels, including a security level providing no security.

11. The method of claim 4, further comprising:
configuring a list of states of the wireless device; and
configuring a list of relationships between the states and actions to be taken by the wireless device, wherein the actions to be taken include at least one of executing an application and providing the interface, and wherein configuring a list of states and configuring a list of relationships include configuring according to the at least one security preference.

12. The method of 4, further comprising receiving user input identifying one of two users, and setting the security preference for the one potential user, wherein a different security preference is associated with the other of the two users.

13. The method of claim 4, wherein the set security preference provides a security level that is inversely related to an accessibility level of the wireless device.

14. An apparatus for controlling access to a wireless device, the apparatus comprising:
means for setting an accessibility preference;
means for providing the accessibility preference to the wireless device;
means for configuring the accessibility preference at the wireless device;
means for requesting accessibility information from a potential user of the wireless device before a limited access feature becomes accessible to the potential user, the means for requesting configured based on the accessibility preference; and
means for controlling access to the limited access feature in response to the accessibility information received.

15. The apparatus of claim 14, wherein the means for setting is selected from a group including the wireless device and a computing device coupled to a wireless service provider equipment via the Internet.

16. The apparatus of claim 14, wherein the means for setting is located remote from at least one of the wireless device and the means for providing.

17. The apparatus of claim 14, wherein the means for setting includes a slider bar configured to represent a range of accessibility levels.

18. The apparatus of claim 14, wherein the means for controlling comprises a Java application management services (JAMS) included in the wireless device.

19. The apparatus of claim 14, wherein the means for requesting comprises a user interface at the wireless device.

20. The apparatus of claim 14, wherein the means for controlling comprises a downloaded application included in the wireless device.

21. The apparatus of claim 14, wherein the limited access feature comprises at least one of features and services available on the wireless device.

22. A computer-readable medium having instructions stored thereon, the instructions executable by a processor to cause the processor to:
notice a selected state of a wireless device; and
in response to the selected state,
invoke at least one application that requests information from a potential user of the wireless device,
access preset data regarding at least one approved user, and
provide access to the wireless device when the potential user is an approved user based on a match between the received information from the potential user and the preset data, wherein the at least one application is invoked a certain number of times and requests different information in accordance with a security level set from among at least three security levels.

23. The computer-readable medium of claim 22, wherein the state is selected from a group including the wireless device being turned on, attempt to access a feature available on the wireless device, and attempt to access a service available on the wireless device.

24. The computer-readable medium of claim 22, wherein the at least one application is a user interface.

25. The computer-readable medium of claim 22, wherein responding to the state comprises:
accessing a catalog that includes the states recognized by the wireless device; and
accessing a registry that relates the states to actions to be taken and the at least one application, wherein the catalog and the registry are configured according to preset preferences.

26. The computer-readable medium of claim 25, wherein the preset preferences are set remote from the wireless device and a service provider equipment.

27. The computer-readable medium of claim 22, wherein the computer-readable medium is microcode.

28. The computer-readable medium of claim 22, wherein the computer-readable medium is a memory of the wireless device.

29. A wireless mobile device, comprising:
a security interface that changes based on a preset security level; and
a memory configured to store a list of relationships between states and actions to be taken by the device, wherein the device is configured to monitor the occurrence of the states and invoke at least the security interface according to the list of relationships, the list of relationships being configured based on the preset security level.

30. The device of claim 29, further comprising a downloaded application, wherein the downloaded application is invoked by the occurrence of the states according to the list of relationships.

31. The device of claim 29, wherein the states are selected from a group including the device being turned on, attempt to access a certain feature available on the device, and attempt to access a certain service available on the device.

32. The device of claim 29, wherein the security interface is a graphical user interface configured to request user identifier information for a potential user of the device.

33. The device of claim 29, wherein the preset security level is set remotely from at least one of the device and a provider equipment.

34. A computer-readable medium storing a display description for setting an accessibility level of a wireless communication device, comprising:
a first portion identifying at least three levels of accessibility;
a second portion selectable by a user to specify one of the at least three levels of accessibility; and
an optional third portion providing a description of the at least three levels of accessibility.

35. The computer-readable medium of claim 34, further comprising:
a fourth portion for identifying a first user associated with the specified level of accessibility; and
a fifth portion for identifying a second user associated with an another level of accessibility specified using the first, second, and third portions, wherein the specified level of accessibility and the another level of accessibility may be dissimilar to each other.

36. The computer-readable medium of claim 34, wherein the user may not be a person using the wireless communication device.
